(19) United States
(12) Patent Application Publication
(10) Pub. No.: US 2026/0124622 A1
(43) Pub. Date: May 7, 2026

(54) BULK MATERIAL MILL FOR PROCESSING COARSE MATERIAL

(71) Applicant: GEBR. PFEIFFER SE, Kaiserslautern (DE)

(72) Inventors: Caroline WOYWADT, Aach (DE); York REICHARDT, Kaiserslautern (DE)

(21) Appl. No.: 19/117,780

(22) PCT Filed: Oct. 5, 2023
(86) PCT No.: PCT/EP2023/077616

§ 371 Date: Apr. 2, 2025

(30) Foreign Application Priority Data
Oct. 6, 2022 (EP) 22200014.3

(51) Int. Cl. B02C 23/14; B02C 23/10

(52) U.S. Cl. CPC B02C 23/14; B02C 23/10

(57) ABSTRACT

A method for processing a bulk material in a processing plant includes feeding bulk material into a grinding and separating device, grinding the bulk material into ground grinding stock, separating the ground grinding stock into fine material and coarse material and discharging the fine material from the grinding and separating device, discharging at least part of the coarse material from the grinding and separating device. The discharged part of the coarse material amounts to at least 65 percent by mass of the fed bulk material, and the discharged part of the coarse material is fed to a subsequent use. A processing plant for processing bulk material and a method of dedusting ore with a processing plant with a mill and classifier are also disclosed.

The present invention relates to a method for processing a bulk material in a processing plant, a processing plant for processing bulk material and the use of a processing plant with a mill and classifier for dedusting ore.

Grinding and separating devices are a frequently used means of grinding and processing raw materials. A fed initial material is fed into the grinding device and comminuted into different fractions, for example fractions of different grain sizes. The different grain sizes are then separated in a separating device. Sufficiently finely ground fractions are discharged from the grinding and separating device in the form of fine material. Coarse fractions with grain sizes that are too large are rejected by the separating device and usually fed back to the grinding device, where they are ground again and thus comminuted further. This cycle is repeated until finally all of the fed initial material is discharged from the grinding and separating device in the form of fine material. Alternatively, part of the coarse material rejected by the separating device may be discharged and thus no longer fed to the grinding device. Discharging substances that are difficult to grind may, for example, increase the productivity of the grinding and separating device. The discharged coarse material is usually dumped or fed back into the grinding device at a later time. The discharged fine material has the desired, sufficiently fine grain sizes and is fed to a subsequent use.

A method for processing multiphase mineral raw materials is known from EP 3 326 720 B1. A raw material fed to a mill is comminuted using grinding rollers. The ground raw material is then separated into fine material and coarse material in a classifier. The fine material is discharged from the plant. Part of the coarse material rejected by the classifier is discharged from the mill. The remaining coarse material is fed back to the grinding rollers and comminuted further until it is finally discharged from the plant in the form of fine material.

The methods known in the prior art have in common that grinding stock is comminuted into a desired grain size and the comminuted grinding stock is then discharged from the plant in the form of fine material. The discharging of unwanted substances or phases that are difficult to grind may take place to a certain part via the coarse material discharge. However, the discharged grain sizes in the coarse material are difficult to control and adjust.

In the present application, grain size is understood to mean the size of individual particles, also known as grains. The term particle is used in the present application as a synonym for grain. If the particles were perfect spheres, the grain size would represent a measure of the respective sphere diameter. However, since the particles are usually not perfectly spherical, but have different shapes, the grain size may be interpreted as an equivalent diameter.

The object of the present invention is to efficiently and precisely separate unwanted substances and grain sizes from ground grinding stock and discharge them from a processing plant. This object is solved by a method for processing a bulk material according to claim 1, a processing plant for processing bulk material according to claim 12 or a use of a processing plant for dedusting ore according to claim 14.

A method according to the present invention for processing a bulk material in a processing plant comprises feeding bulk material into a grinding and separating device, grinding the bulk material in a grinding device into ground grinding stock, separating the ground grinding stock in a separating device into fine material and coarse material, discharging the fine material from the grinding and separating device and discharging at least a part of the coarse material from the grinding and separating device. The discharged part of the coarse material from the grinding and separating device amounts to at least 65 percent by mass of the fed bulk material. The discharged part of the coarse material may be fed to a subsequent use. The grinding and separating device comprises the grinding device and the separating device.

In technical terms, separating the ground grinding stock may also be referred to as classifying, grading or sorting.

The discharged fine material may be dumped or sent to a landfill or to one or more separate further processing stages. For example, the fine material may be sent to a separate fine material processing stage. Alternatively or additionally, the fine material may be used as a filler.

The fed bulk material may have at least a first phase and a second phase. The coarse material may have a higher proportion of the first phase than the fed bulk material. The coarse material may have a higher proportion of the first phase than the fine material. The fine material may have a higher proportion of the second phase than the coarse material. The fine material may have a higher proportion of the second phase than the fed bulk material.

The fed bulk material may be a solid material with different phases. The fed bulk material may be a raw material with several mineral phases. The fed bulk material may be a composite material, for example concrete or a composite plastic. The fed bulk material may be in one piece or in the form of several solids.

The first phase and the second phase may be bonded together in the bulk material. The first phase and the second phase may be loose in the bulk material.

The first phase and the second phase may have particles. The particles of the first phase may have a larger grain size on average than the particles of the second phase. The particles of the first phase may, on average, have a higher density than the particles of the second phase. The particles of the first phase may have, on average, a larger grain size and a higher density than the particles of the second phase.

The first phase and the second phase may have different grindability. The second phase may have a better grindability than the first phase. The second phase may be comminuted faster and/or into smaller particles, i.e. particles with a smaller grain size. The second phase may be accumulated in the fine material by the separating device due to its grain size. The first phase may be enriched in the coarse material by the separating device due to its grain size.

The first phase may have the same material as the second phase. The first phase may consist of the same material as the second phase. The first phase and the second phase may be largely identical, so that the only difference between them is the grain size.

The first phase may have a different material than the second phase.

The maximum grain size of the particles in the fine material may be 0.1 millimeters, preferably 0.05 millimeters, preferably 0.01 millimeters, preferably 0.005 millimeters. The maximum grain size may only represent a theoretical threshold. In practice, the separation into fine material and coarse material is also influenced by other factors, such as the density and/or shape of the particles, so that particles with a grain size larger than the maximum grain size are sometimes enriched in the fine material. Accordingly, the maximum grain size may represent a grain size threshold value which is undercut by 90 percent by mass, in particular 95 percent by mass, preferably 99 percent by mass of the particles in the fine material.

The second phase may have a grain size that is not preferred for further processing, in particular non-preferred grain sizes. This non-preferred grain size or grain sizes may be discharged from the grinding and separating device as fine material.

In the fed bulk material, the first phase may be arranged at least partially, in particular completely, within the second phase. In the fed bulk material, the second phase may be arranged partially, in particular completely, within the first phase. In the fed bulk material, the first phase may be arranged at least partially connected to the second phase.

The particles of the fed bulk material may be composed of the first phase and the second phase. The fed bulk material may also have other phases. During grinding, the first phase and the second phase may be at least partially detached from one another. During grinding, the first phase and the second phase may be at least partially dissolved from each other and from the other phases. During grinding, the particles of the first phase and/or the particles of the second phase may be comminuted.

The discharged part of the coarse material may amount to at least 70 percent by mass, in particular at least 75 percent by mass, in particular at least 85 percent by mass, preferably at least 95 percent by mass of the fed bulk material.

The discharged fine material may amount to a maximum of 35 percent by mass, in particular a maximum of 25 percent by mass, in particular a maximum of 15 percent by mass, preferably a maximum of 10 percent by mass, preferably a maximum of 5 percent by mass of the fed bulk material.

The discharged fine material may amount to at least 1 percent by mass, in particular at least 2 percent by mass, in particular at least 3 percent by mass, in particular at least 5 percent by mass, in particular at least 10 percent by mass of the fed bulk material.

The grinding and separating device may have a grinding device and a separating device. The grinding device may be a mill, in particular a vertical mill. The separating device may be a classifier, in particular a rotary classifier. The grinding and separating device may be a mill-classifier combination.

In the separating device, separation into fine material and coarse material may take place. The fine material may be discharged from the grinding and separating device. The ground grinding stock rejected by the separating device, the so-called coarse material, may be discharged separately from the grinding and separating device. Parts of the coarse material rejected by the separating device may also be fed back into the grinding device.

The classifier, in particular the rotary classifier, may have an adjustable rotational speed. The classifier may be driven by a motor. A control unit may control the motor and thus the rotational speed of the classifier, in particular continuously/steplessly.

The discharged fine material may be controllable via the rotational speed of the classifier. A grain size distribution in the fine material may be controllable or at least influenceable via the rotational speed of the classifier. A density distribution in the fine material may be controllable or at least influenced by the rotational speed of the classifier. The proportion of the fed bulk material discharged as fine material may be controllable via the rotational speed of the classifier. The rotational speed of the classifier may be used to set a theoretical maximum value for the grain sizes in the fine material. The rotational speed of the classifier may be used to set a theoretical maximum value for the densities in the fine material.

The discharged coarse material may be controllable via the rotational speed of the classifier. A grain size distribution in the coarse material may be controllable via the rotational speed of the classifier. A density distribution in the coarse material may be controllable via the rotational speed of the classifier. The proportion of the fed bulk material discharged as coarse material may be controllable via the rotational speed of the classifier. The rotational speed of the classifier may be used to set a theoretical minimum value for the grain sizes in the coarse material. The rotational speed of the classifier may be used to set a theoretical minimum value for the densities in the coarse material

The rotational speed of the classifier may be used to set a preferred threshold for the grain size in the fine material. The person skilled in the art is aware that this grain size threshold does not necessarily represent a 100 percent sharp limit. The discharged fine material is generally influenced not only by its grain size, but also, for example, by its density and/or shape. The adjustable preferred grain size threshold may therefore be interpreted as a quantile value. A significant proportion, for example at least 90 percent by mass, preferably at least 95 percent by mass, preferably at least 99 percent by mass, of the discharged fine material may have grain sizes smaller than or equal to the set preferred threshold. A significant proportion, for example at least 90 percent by mass, preferably at least 95 percent by mass, preferably at least 99 percent by mass, of the coarse material rejected by the classifier may have grain sizes larger than the set preferred grain size limit.

The rotational speed of the classifier may be used to set a preferred threshold for the density of the fine material. The person skilled in the art is aware that this density threshold is not necessarily a 100 percent sharp limit, because the discharged fine material is not only influenced by its density, but also, for example, by its grain size and/or shape. The adjustable preferred density threshold may therefore be regarded as a quantile value. A significant proportion, for example at least 90 percent by mass, preferably at least 95 percent by mass, preferably at least 99 percent by mass, of the discharged fine material may have densities less than or equal to the set preferred threshold. A significant proportion, for example at least 90 percent by mass, preferably at least 95 percent by mass, preferably at least 99 percent by mass, of the coarse material rejected by the classifier may have densities greater than the set preferred density threshold.

The fed bulk material may consist primarily of ore, in particular metal ore, preferably iron ore. The fed bulk material may have a proportion of ore of at least 10 percent by mass, preferably at least 30 percent by mass, preferably at least 50 percent by mass. The fed bulk material may have a proportion of metal ore of at least 10 percent by mass, preferably at least 30 percent by mass, preferably at least 50 percent by mass. The fed bulk material may have a proportion of iron ore of at least 10 percent by mass, preferably at least 30 percent by mass, preferably at least 50 percent by mass.

The metal content in the metal ore may be at least 0.1 percent by mass, preferably at least 1 percent by mass, preferably at least 5 percent by mass of the metal ore. The iron content in the iron ore may be at least 1 percent by mass, preferably at least 10 percent by mass, preferably at least 30 percent by mass, preferably at least 50 percent by mass of the iron ore.

The fed bulk material may consist primarily of concrete, in particular old concrete or recycling concrete. The fed bulk material may have a proportion of concrete of at least 10 percent by mass, preferably at least 30 percent by mass, preferably at least 50 percent by mass.

The concrete fed as bulk material may contain cement stone, hydrated cement or set cement and aggregate. In the following, only the term cement stone is used as a representative of cement stone, hydrated cement and set cement. The cement stone and the aggregate may be separated from each other in the grinding device. The cement stone contained in the fed concrete may have better grindability than the aggregate contained in the fed concrete. Most of the cement stone contained in the fed concrete may be discharged as fine material. Most of the aggregate contained in the fed concrete may be discharged as coarse material.

The method may be a method for ore processing, in particular metal ore processing, in particular iron ore processing. Metal ore may be a mixture of rock and metal. The metal may generally be present as a metal compound in the metal ore. According to the present invention, the term metal compound also includes all sulfidic and oxidic compounds. Iron ore may be a mixture of rock and iron. The iron may generally be present as an iron compound in the iron ore.

Metal contained in the metal ore may be dissolved from rock contained in the metal ore by the grinding device. The rock may have better grindability than the metal. The rock may have a smaller grain size on average than the metal after the grinding process. The rock may be at least partially in the form of dust after the grinding process. Due to the smaller grain size, the rock may be selectively enriched in the fine material by means of the separating device and discharged as such. Due to the larger grain size, the metal may be selectively enriched in the coarse material and discharged as such. This selective enrichment may separate metal and rock efficiently and precisely.

Iron contained in the iron ore may be separated from rock contained in the iron ore by the grinding device. The rock may have a better grindability than the iron. The rock may have a smaller average grain size than the iron after the grinding process. The rock may be at least partially in the form of dust after the grinding process. Due to the smaller grain size, the rock may be selectively enriched in the fine material by means of the separating device and discharged as such. Due to the larger grain size, the iron may be selectively enriched in the coarse material and discharged as such. This selective enrichment may allow iron and rock to be separated efficiently and precisely.

The process may be a method for processing old concrete or recycling concrete. In the following, only the term old concrete will be used as a representative term for old concrete or recycling concrete. The method may be a method for recycling old concrete. The method may be a method for processing and recycling old concrete. The processing and recycling of raw materials, especially concrete, has become increasingly important in recent years due to ecological and economic aspects. Concrete may contain different aggregates, also known as gravel or sand, which are bound together by cement stone. The aggregates present in the concrete may be separated from the cement stone in the grinding device. The cement stone may have a better grindability than the aggregates. The cement stone may be present as cement stone dust after the grinding process. For further use of the aggregate, it may be advantageous if the aggregate is free of cement stone, in particular cement stone dust. The cement stone dust may be enriched in the fine material by the separating device and thus separated from the aggregate. The aggregate may be enriched in the coarse material by the separating device.

The method may be a method for processing clay in connection with clay calcination. The method may be a method for processing slags, in particular metallurgical slags.

The coarse material may be rejected by the separating device towards the grinding device. The coarse material may be directed from the separating device into a grit cone. The rejected coarse material may be conveyed to the grinding device. The grit cone may direct the rejected coarse material to the grinding device. The separating device may be arranged vertically above the grinding device. The rejected coarse material may be conveyed back towards the grinding device by means of gravity.

The discharging of at least one part of the coarse material from the grinding and separating device may take place between the separating device and the grinding device. The discharging of at least one part of the coarse material from the grinding and separating device may take place via a screw conveyor. For example, the coarse material rejected by the separating device may fall onto the screw conveyor due to gravity. The grit cone may direct at least part of the rejected coarse material onto the separating device, in particular the screw conveyor. The discharging of the at least one part of the coarse material from the grinding and separating device may take place via a chute. The discharging of at least one part of the coarse material from the grinding and separating device may take place via a chute with subsequent air exclusion. The discharging of at least one part of the coarse material from the grinding and separating device may take place via an air conveyor channel. The discharging of at least one part of the coarse material from the grinding and separating device may take place via an air conveyor channel with subsequent air exclusion.

All of the coarse material rejected by the separating device may be discharged from the grinding and separating device.

The discharged coarse material may be fed to a second separating device. The second separating device may divide the discharged coarse material into at least two fractions, in particular at least three fractions, with different grain sizes from one another. The second separating device may, for example, be a screening device or a second classifier.

During the processing of concrete, most of the cement stone contained in the fed concrete may be discharged as fine material. Most of the aggregate contained in the fed concrete may be discharged as coarse material and fed to the second separating device. The discharged aggregate may be divided into aggregates of different grain sizes in the second separating device. The discharged aggregate may, for example, be divided into sand and gravel in the second separating device.

The separating device may be arranged above the grinding device. The discharging of at least one part of the coarse material may take place between the separating device and the grinding device.

A processing plant according to the present invention for processing bulk material comprises a grinding and separating device, a first discharge device and a second discharge device. The grinding and separating device may comprise a grinding device and a first separating device. The grinding device may be adapted to grind a bulk material fed into the grinding and separating device into ground grinding stock. The first separating device may be adapted to separate the ground grinding stock into fine material and coarse material. The first discharge device may be adapted to discharge the fine material from the grinding and separating device. The second discharge device may be adapted to discharge at least part of the coarse material from the grinding and separating device. The processing plant further comprises a second separating device. The second separating device may be adapted to separate the discharged coarse material into at least a first fraction and a second fraction. Particles in the first fraction may have a smaller grain size on average than particles in the second fraction. The second separating device may be adapted to separate the discharged coarse material into at least a first fraction, a second fraction and a third fraction. The second separating device may be adapted to separate the discharged coarse material into at least a first fraction, a second fraction, a third fraction and a fourth fraction. The fractions may have different average grain sizes.

Alternatively, the processing plant may be adapted to operate without a second separating device. The processing plant may have a control which is adapted to control the processing plant in such a way that the part of the coarse material discharged via the second discharge device is at least 65 percent by mass of the fed bulk material. The control may be purely controlling, or it may perform feedback control based on a measured value. The measured value may be indicative of the relative or absolute quantity of the discharged part of the coarse material. The measured value may, for example, reflect the mass flow of the discharged part of the coarse material.

The grinding and separating device may be a mill-classifier combination. The grinding device may be a mill, in particular a vertical mill. The mill may comprise a plurality of grinding rollers. The mill may comprise a grinding table.

The second separating device may be directly downstream of the second discharge device. The first discharge device may be arranged higher than the first separating device. The first discharge device may be arranged vertically above the first separating device.

The ground grinding stock may be transported from the grinding device to the first separating device by means of a process gas stream, in particular heated air. The first discharge device may be an air duct. The fine material may be transported from the first discharge device, in particular by means of a process gas stream, into a filter or a cyclone. In the filter or cyclone, the fine material may be filtered from the process gas stream and collected. The process gas stream may then be returned to the grinding and separating device.

The second discharge device may be a screw conveyor. The second discharge device may be a chute with air exclusion. The second discharge device may be an air channel with air exclusion. The second discharge device may be arranged between the first separating device and the grinding device. The second discharge device may be arranged vertically between the first separating device and the grinding device.

The second discharge device may be adapted to discharge at least 65 percent by mass, in particular at least 75 percent by mass, in particular at least 85 percent by mass, preferably at least 95 percent by mass of the fed bulk material as coarse material.

The first discharge device may be adapted to discharge a maximum of 35 percent by mass, in particular a maximum of 25 percent by mass, in particular a maximum of 15 percent by mass, preferably a maximum of 5 percent by mass of the fed bulk material as fine material.

The first separating device may be a classifier, in particular a rotary classifier. The rotational speed of the classifier may be adjustable, in particular continuously/steplessly adjustable. The processing plant may further comprise a motor. The separating device, in particular the classifier, may be driven by the motor.

The grinding and separating device may comprise a control unit. The control unit may be configured to control the proportion of the fine material discharged via the first discharge device. The proportion of the fine material may be specified in relation to the fed bulk material. The control unit may be electronically connected to the motor. The control unit may be configured to regulate the rotational speed of the motor and thus the rotational speed of the classifier. The control unit may be configured to continuously/steplessly regulate the rotational speed of the motor and thus the rotational speed of the classifier. The rotational speed of the classifier may be used to regulate the proportion of discharged fine material. The rotational speed of the classifier may be used to regulate a theoretical maximum grain size in the fine material.

The second separating device may be a classifier. The second separating device may be a screening device. The second separating device may be adapted to separate the discharged coarse material into a first fraction and a second fraction. The second separating device may be adapted to separate the discharged coarse material into a first fraction, a second fraction and a third fraction. The second separating device may be adapted to separate the discharged coarse material into a first fraction, a second fraction, a third fraction and a fourth fraction. The fractions may have different average grain sizes to one another. The fractions may have different average densities in relation to each other. The fractions may have different average grain sizes and densities relative to each other.

A further aspect of the invention comprises a use of a processing plant with mill and classifier for dedusting ore. The ore is discharged from the processing plant predominantly as coarse material.

The classifier may be arranged above the mill. Above means in particular that the classifier is arranged vertically higher than the mill in relation to the ground, in particular the surface of the earth. The classifier may be arranged centrally above the mill in the vertical direction. The classifier may be arranged above the mill, offset transversely to the vertical direction. In particular, the classifier is arranged above a grinding table of the mill. In particular, the classifier is arranged above grinding rollers of the mill.

The classifier is in particular a rotary classifier. The classifier comprises elements rotating about an axis, in particular a vertical axis.

Dedusting may be referred to as the discharging of particles of small grain sizes, in particular undesired small grain sizes. Finely ground dust may cause problems during further processing of the processed ore. Particles with a grain size smaller than 0.02 millimeters, in particular smaller than 0.01 millimeters, may be referred to as dust.

Dedusting may be carried out by discharging fine material. The grain sizes of particles in the fine material may be controlled via the rotational speed of the classifier. A maximum value of the grain sizes of particles in the fine material may be controlled via a rotational speed of the classifier. The ore contains metal compounds and rocks in particular. The ore, in particular the metal compounds and the rocks, may be ground in the mill. The ground metal compounds may be enriched predominantly in the coarse material. The ground stones may be enriched predominantly in the fine material.

The ore may be metal ore, in particular iron ore. The ore is ground and comminuted in the mill. Metal compounds contained in the ore, in particular iron compounds, may be dissolved from rocks contained in the ore by the grinding process. The ground rocks and metal compounds, in particular iron compounds, may be conveyed to the classifier and largely separated from each other by the classifier. The ground rocks may be enriched mainly in the fine material. The ground metal compounds, in particular iron compounds, may be enriched predominantly in the coarse material.

In the following, advantageous embodiments of the invention are explained in more detail with reference to the attached figures.

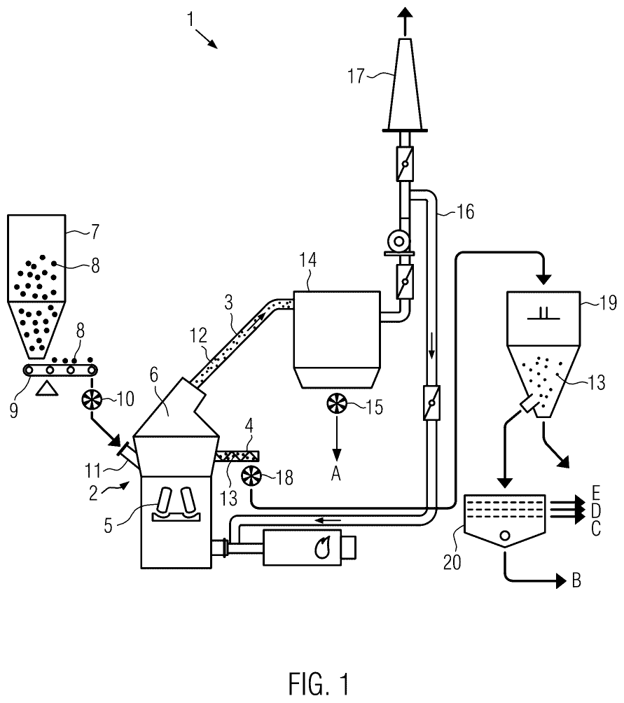

FIG. 1 shows a schematic representation of a processing plant according to the invention for processing bulk material.

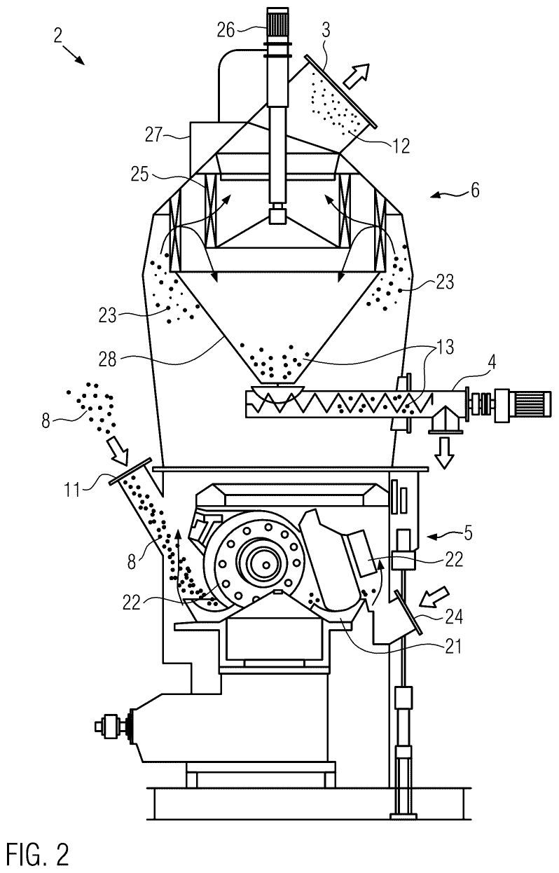

FIG. 2 shows a vertical section through a processing plant according to the invention for processing bulk material.

FIG. 1 shows a schematic representation of a processing plant 1 according to the invention. The processing plant 1 comprises a grinding and separating device 2, a first discharge device 3 and a second discharge device 4. The grinding and separating device 2 comprises a grinding device 5 and a first separating device 6.

Bulk material 8 stored in a silo 7 is conveyed via a conveyor belt 9 and a first rotary valve 10 into a material feed opening 11 of the grinding and separating device 2 and fed to the grinding device 5. After the grinding process, the bulk material 8 is transported by a process gas stream to the first separating device 6. In the embodiment shown in FIG. 1, the first separating device 6 is adapted in the form of a rotary classifier. The first separating device 6 separates the ground bulk material 8 into fine material 12 and coarse material 13.

The fine material 12 is discharged from the grinding and separating device 2 via the first discharge device 3 by means of a process gas stream and transported into a filter 14. In the filter 14, the fine material 12 is separated from the process gas stream and collected. The fine material 12 collected in the filter 14 may be discharged from the filter 14 via a second rotary valve 15. Part of the filtered process gas stream is returned to the grinding and separating device 2 via a pipeline 16. The remaining process gas stream is discharged from the processing plant 1 via an outlet 17. The coarse material 13 is discharged from the grinding and separating device 2 via the second discharge device 4. In the embodiment shown in FIG. 1, the second discharge device 4 is adapted in the form of a screw conveyor. The discharged coarse material 13 is fed to an intermediate store 19 via a third rotary valve 18.

From the intermediate storage 19, the coarse material 13 may then be discharged from the processing plant 1 or fed to a second separating device 20. The second separating device 20 shown in FIG. 1 is a screening device and separates the coarse material 13 into four fractions B, C, D, E with different grain sizes. The fine material 12 discharged by the filter 14 may be regarded as a first fraction A. Accordingly, the second separating device 20 separates the coarse material 13 into a second fraction B, a third fraction C, a fourth fraction D and a fifth fraction E.

FIG. 2 shows a section of a processing plant 1 according to the invention. Essentially, the grinding and separating device 2 of the processing plant 1 is shown in FIG. 2. Bulk material 8 is fed to the grinding device 5 via the material feed opening 11. In the embodiment shown in FIG. 2, the grinding device 5 comprises a grinding table 21 and several grinding rollers 22. The grinding rollers 22 crush the bulk material 8 into ground grinding stock 23.

A process gas stream, for example air or hot gas, is introduced into the grinding and separating device 2 via an air inlet opening 24 in the lower region of the grinding device 5. The process gas stream transports sufficiently finely ground grinding stock 23 to the first separating device 6. In the embodiment shown in FIG. 2, the first separating device 6 is a rotary classifier. The first separating device 6 comprises a blade wheel 25 which is driven by a motor 26. The grinding and separating device 2 further comprises a control unit 27. The control unit 27 is electronically connected to the motor 26 and is adapted to control the motor 26 and thus the rotational speed of the blade wheel 25. The speed of rotation of the blade wheel 25 may be continuously/steplessly regulated by the control unit 27 via the motor 26.

Sufficiently finely ground grinding stock 23 is discharged from the first separating device 6 as fine material 12 via the first discharge device 3. The grinding and separating device further comprises a grit cone 28. Ground grinding stock 23 that is not sufficiently finely ground, so-called coarse material 13, is rejected by the separating device 6 in the direction of the grit cone 28. The grit cone 28 directs the coarse material 13 to the second discharge device 4. In the embodiment shown in FIG. 2, the second discharge device 4 is adapted in the form of a screw conveyor. The coarse material 13 is discharged from the grinding and separating device 2 via the second discharge device 4. The discharged coarse material 13 is then fed to a subsequent use.

1. A method for processing a bulk material (8) in a processing plant (1), comprising:
feeding the bulk material (8) into a grinding and separating device (2), the grinding and separating device (2) comprising a grinding device (5) and a separating device (6);
grinding the bulk material (8) in the grinding device (5) into ground grinding stock (23)l
separating the ground grinding stock (23) in the separating device (6) into fine material (12) and coarse material (13);
discharging the fine material (12) from the grinding and separating device (2); and
discharging at least part of the coarse material (13) from the grinding and separating device (2);
wherein the discharged part of the coarse material (13) amounts to at least 65 percent by mass of the fed bulk material (8).

2. The method for processing a bulk material according to claim 1, wherein the fed bulk material (8) has at least a first phase and a second phase, wherein the coarse material (13) has a higher proportion of the first phase than the fed bulk material (8).

3. The method for processing a bulk material according to claim 2, wherein the first phase and the second phase have particles, wherein the particles of the first phase have on average a larger grain size than the particles of the second phase and/or the particles of the first phase have on average a higher density than the particles of the second phase.

4. The method for processing a bulk material according to claim 2, wherein the first phase has a different material than the second phase.

5. The method for processing a bulk material according to one claim 1, wherein a maximum grain size of particles in the fine material (12) is 0.1 millimeters,

6. The method for processing a bulk material according to one claim 1, wherein the discharged part of the coarse material (13) is at least 75 percent by mass of the fed bulk material (8).

7. The method for processing a bulk material according to one claim 1, wherein the separating device (6) is a rotary classifier.

8. The method for processing a bulk material according to claim 7, wherein a grain size distribution in the coarse material (13) is controllable or at least influenceable via a rotational speed of the rotary classifier.

9. The method for processing a bulk material according to one claim 1, wherein the bulk material (8) consists primarily of ore.

10. The method for processing a bulk material according to one claim 1, wherein the bulk material (8) consists primarily of concrete.

11. The method for processing a bulk material according to one claim 1, wherein the separating device (6) is a first separating device (6) and the discharged coarse material (13) is supplied to a second separating device (20), wherein the second separating device (20) divides the discharged coarse material (13) into at least two fractions with grain sizes and/or densities that differ from one another.

12. A processing plant (1) for processing bulk material (8), comprising:
a grinding and separating device (2) comprising a grinding device (5) and a first separating device (6), wherein the grinding device (5) is adapted to grind a fed bulk material (8) into ground grinding stock (23), and the first separating device (6) is adapted to separate the ground grinding stock (23) into fine material (12) and coarse material (13);
a first discharge device (3) for discharging the fine material (12) from the grinding and separating device (2);
a second discharge device (4) for discharging the coarse material (13) from the grinding and separating device (2);
a control adapted to control the processing plant (1) such that a part of the coarse material (13) discharged via the second discharge device (4) is at least 65 percent by mass of the fed bulk material (8); and
a second separating device (20), wherein the second separating device (20) is adapted to separate the discharged part of the coarse material (13) into at least a first fraction and a second fraction, wherein particles in the first fraction have on average a smaller grain size and/or lower density than particles in the second fraction.

13. The processing plant for processing bulk material according to claim 12, wherein the grinding and separating device (2) comprises a control unit (27), wherein the control unit (27) is configured to control a proportion of fine material (12) discharged via the first discharge device (3).

14. A method for dedusting iron ore with a processing plant (1) with a mill and a classifier, the method comprising:
discharging the iron ore predominantly as coarse material (8) from the processing plant (1) by a discharge device (4) arranged between the classifier and the mill;
wherein the classifier is arranged above the mill.

15. The method of claim 14, further comprising dedusting the iron ore by discharging fine material (12).

16. The method for processing a bulk material according to claim 1, wherein the separating device (6) is arranged above the grinding device (5) and the discharging of the least part of the coarse material (13) takes place between the separating device (6) and the grinding device (5).

17. The processing plant for processing bulk material according to claim 12, wherein the second separating device (20) is adapted to separate the discharged part of the coarse material (13) into at least a first fraction, a second fraction and a third fraction, wherein the fractions on average have different grain sizes and/or densities with respect to each other.
